(19) United States
(12) Patent Application Publication
(10) Pub. No.: US 2006/0180428 A1
(43) Pub. Date: Aug. 17, 2006

(54) Bill processing device

(75) Inventor: Kazuei Yoshioka, Tokyo (JP)

Correspondence Address: LEYDIG VOIT & MAYER, LTD, 700 THIRTEENTH ST. NW, SUITE 300, WASHINGTON, DC, 20005-3960, US

(73) Assignees: Aruze Corp., Tokyo (JP); Seta Corp., Tokyo (JP)

(21) Appl. No.: 11/355,188

(22) Filed: Feb. 16, 2006

(30) Foreign Application Priority Data
Feb. 17, 2005 (JP) P2005-040847

(51) Int. Cl. G07F 7/04

(52) U.S. Cl. 194/206

(57) ABSTRACT

A bill processing device includes: a bill insertion slot into which a bill is inserted; a bill conveying mechanism that conveys the bill inserted from the bill insertion slot along the insertion direction or returns the bill toward the bill insertion slot; a bill validating sensor that validates whether the bill inserted into the bill insertion slot is valid or not; a bill storing section that stores bills in a stacked manner in the direction orthogonal to the bill insertion direction; a sorting mechanism that stores the bills in the bill storing section in a stacked manner and that performs the sorting between the bills and a bill which is subsequently inserted; and a noncontact mechanism that causes the bills stored in the bill storing section not to come in contact with the bill conveying mechanism, until the bill is carried in the storage position.

### CROSS-REFERENCE TO THE RELATED APPLICATION(S)

This application is based upon and claims a priority from prior Japanese Patent Applications No. 2005-040847 filed on Feb. 17, 2005, the entire contents of which are incorporated herein by reference.

### BACKGROUND OF THE INVENTION

1. Field of the Invention

The present invention relates to a bill processing device which validates a bill to store, and more specifically, to a bill processing device which is installed in a game hall, in which pachinko (Japanese pinball game) machines or slot machines (hereinafter, referred to as ‘game machine’) are installed, so as to be arranged between the game machines.

2. Description of the Related Art

In general, in a game hall such as a pachinko hall, vertically long game medium dispensers (also referred to as a sand device) are installed for user's convenience so as to dispense pachinko balls or coins (game mediums) between adjacent game machines in a region where a plurality of game machines are installed (also referred to as ‘an island’). The game medium dispensers are mounted on frames which are installed and fixed between the respective game machines, and bills, coins, prepaid cards, and the like are inserted through the corresponding insertion ports thereto. Then, the game mediums are actually dispensed, or a signal, which stimulates the game mediums to be dispensed, is transmitted to the game machine.

For example, a game medium dispenser, which is constructed so as to deal with bills, coins, and prepaid cards, has a bill processing device, a coin processing device, a recording medium processing device which receives a recording medium such as a prepaid card or an IC card so as to read recorded information or write information, a control section which controls the respective devices and transmits a signal for stimulating the game medium to be dispensed to a game machine, and a power supply section.

The above-described bill processing device is provided with, for example, a bill validating section which validates whether an inserted bill is valid or not valid and a bill storing section (a stacker) which stores a bill which is determined to be valid by the bill validating section, as disclosed in JP-A-8-123991. In the known bill processing device, a bill inserted into a bill insertion slot is conveyed inside by a bill conveying mechanism while the validity of the bill is read by a sensor, and the bill which is determined to be valid is conveyed further inside by the bill conveying mechanism so as to be stored in the bill storing section in a stacked manner. In other words, in the bill processing device, a bill is inserted horizontally with respect to the bill insertion slot, and the bill which is determined to be valid by the bill validating section is conveyed further inside so as to be sequentially stored in a stacked manner in the bill storing section which is installed on the conveyance path thereof.

Consequently, the inside space of the overall device is needed, and thus the overall device becomes large-sized. Further, since a bill is inserted horizontally and stored in a stacked manner as it is, the overall device also becomes large-sized in the vertical direction.

Subsequently, for example, as disclosed in JP-UM-A-7-23757, a bill processing device is known, in which bills are inserted vertically and the bills which are determined to be valid by a bill validating section are stored laterally in a stacked manner as they are, which makes it possible to make the overall device compact.

### SUMMARY OF THE INVENTION

In general, however, a bill validating section arranged in a bill processing device is constructed so as to irradiate light on a bill which is being inserted, to compare the detection data obtained by the reflected light and transmitted light with data on a normal bill which has been previously stored, and to determine the validity of the bill. In this case, when the validation of the bill is performed, the whole region in the longitudinal direction of the bill which is being conveyed may be detected to thereby improve the validation precision.

In the bill processing device disclosed in JP-UM-A-7-23757, however, if it is constructed so that the entire region in the longitudinal direction of the bill which is being conveyed is detected, the inside space in the overall device is wasted. In other words, the validation of the bill is performed when the bill is conveyed inside, and the bill is shifted to the side in a state where the whole region in the longitudinal direction is completely read. Therefore, in the downstream side from the bill validating sensor, a space having a larger length than at least the bill is needed. In general, a game medium dispenser, which is installed between game machines, is required to be as small as possible. Further, the bill processing device integrated with the dispenser is also required to be compactly stored in a limited space.

In addition, when the overall bill processing device is made compact, it is highly likely that the interference or collision occurs between when the bill which is determined to be valid after validation is stored and when a bill which is subsequently inserted is validated. Therefore, it is preferable that the distribution process between both bills be performed in a stable state. Particularly, in the construction where the bill conveying mechanism and the bill storing section are provided in parallel to each other in order to make the overall bill processing device compact, if the bills are curved or flexed due to an influence of the state of the stacked bills such as humidity or the used state of the bills, the bills sequentially stored in a stacked manner can come in contact with the conveying mechanism (such as a conveying roller or conveying belt) which is being driven so as to convey the next bill, such that a bill jam can occur inside the bill processing device.

An advantage of the present invention is that it provides a bill processing device that can effectively use the limited installation space to reduce the size and can process bills sequentially inserted in a stable state.

According to an aspect of the invention, a bill processing device includes a bill insertion slot into which a bill is inserted; a bill conveying mechanism that conveys the bill inserted from the bill insertion slot along the insertion direction or returns the bill, which is being inserted, toward the bill insertion slot; a bill validating sensor that validates whether the bill inserted into the bill insertion slot is valid or not valid; a bill storing section that is provided in parallel to the bill conveying mechanism so as to store bills in a stacked manner in the direction orthogonal to the bill insertion direction; a sorting mechanism that stores the bills, which are determined to be valid by the bill validating sensor, in the bill storing section in a stacked manner and that performs the sorting between the bills and a bill which is subsequently inserted; and a noncontact mechanism that causes the bills stored in the bill storing section not to come in contact with the bill conveying mechanism, until the bill is carried in the storage position of the bill storing section by the bill conveying mechanism.

According to the bill processing device having such a construction, the bill inserted into the bill insertion slot is conveyed as it is by the bill conveying mechanism, and the validity of the bill is determined by the bill validating sensor when it is being conveyed. The bill which is determined to be valid is sequentially stored in a stacked manner in the direction orthogonal to the bill insertion direction in the bill storing section provided in parallel to the bill conveying mechanism. During the storing operation, the sorting is performed by the sorting mechanism so that the bills stored in a stacked manner do not interfere with a bill which is subsequently inserted by the bill conveying mechanism. Therefore, between the bills stored in a stacked manner and a bill which is being inserted, a jam or clogging does not occur. In addition, since the bill storing section stores a transferred bill in a stacked manner in the direction orthogonal to the bill insertion direction, bills can be effectively stored in a limited space in the width direction. Further, since the bills stored in the bill storing section in a stacked manner are maintained so as not to come in contact with the bill conveying mechanism by the noncontact mechanism, the bills stored in a stacked manner are not unnecessarily moved due to contact with the bill conveying mechanism, and a bill jam or the like is reliably prevented. In the bill conveying mechanism which is in a noncontact state, a bill jam can occur in a portion opposite to the bills stored in a stacked manner, corresponding to a portion (conveying section) such as a conveying belt or driving roller which is rotatably driven.

According to the construction of the present invention, a bill processing device is obtained, which effectively uses limited installation space to reduce the size and bills which are sequentially inserted can be processed in a stable state without a jam occurring.

### BRIEF DESCRIPTION OF THE DRAWINGS

These and other objects and advantages of the present invention will be more fully apparent from the following detailed description taken in conjunction with the accompanying drawings, in which:

FIG. 1 is a diagram illustrating the overall construction of an embodiment of a bill processing device according to the present invention;

FIG. 2 is a diagram illustrating the inner construction of the bill processing device;

FIG. 3 is a perspective view illustrating the schematic construction of a noncontact mechanism and a guide unit which guides the leading end of a bill, which is being conveyed, in a curved manner;

FIG. 4A is a side view showing a state where the noncontact mechanism comes in contact with a bill, seen from the direction of an arrow C of FIG. 1 or 2;

FIG. 4B is a side view showing a state where the noncontact mechanism is retreating, seen from the direction of the arrow C of FIG. 1 or 2;

FIG. 5A is a diagram explaining an operation of a shutter mechanism discharging bills, showing a state where a shutter is closed;

FIG. 5B is a diagram explaining an operation of the shutter mechanism discharging the bills, showing a state where the shutter is opened;

FIG. 6 is a plan view illustrating the construction of a push-out mechanism;

FIG. 7A is a perspective view illustrating the construction of the push-out mechanism, showing a state before bills are discharged;

FIG. 7B is a perspective view illustrating the construction of the push-out mechanism, showing a state where the bills are being discharged;

FIG. 8 is a diagram showing a state when bills are being discharged from the bill processing device;

FIG. 9 is a block diagram showing a constructional example of a control unit which controls an operation of the bill processing device; and

FIGS. 10A to 10F are schematic views consecutively showing operations of the bill conveying mechanism, the guide unit, and the noncontact mechanism when a bill is inserted.

### DETAILED DESCRIPTION OF THE EMBODIMENTS

Hereinafter, an embodiment of the present invention will be described with reference to the drawings.

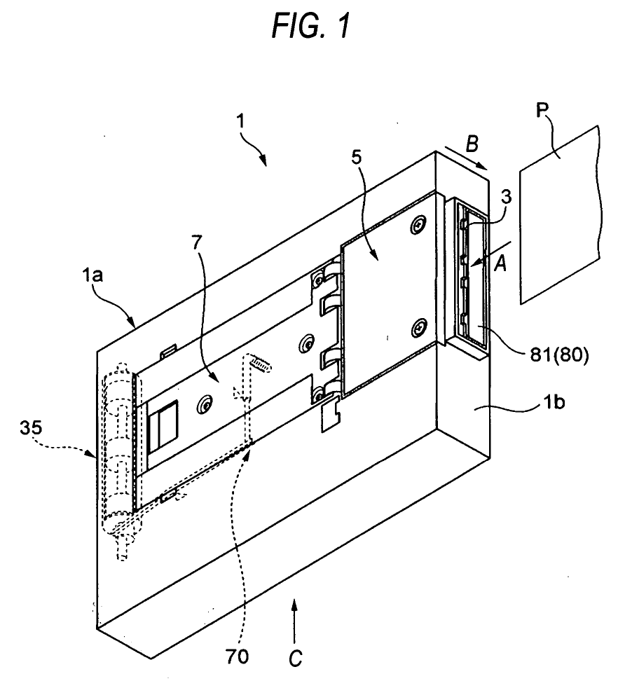

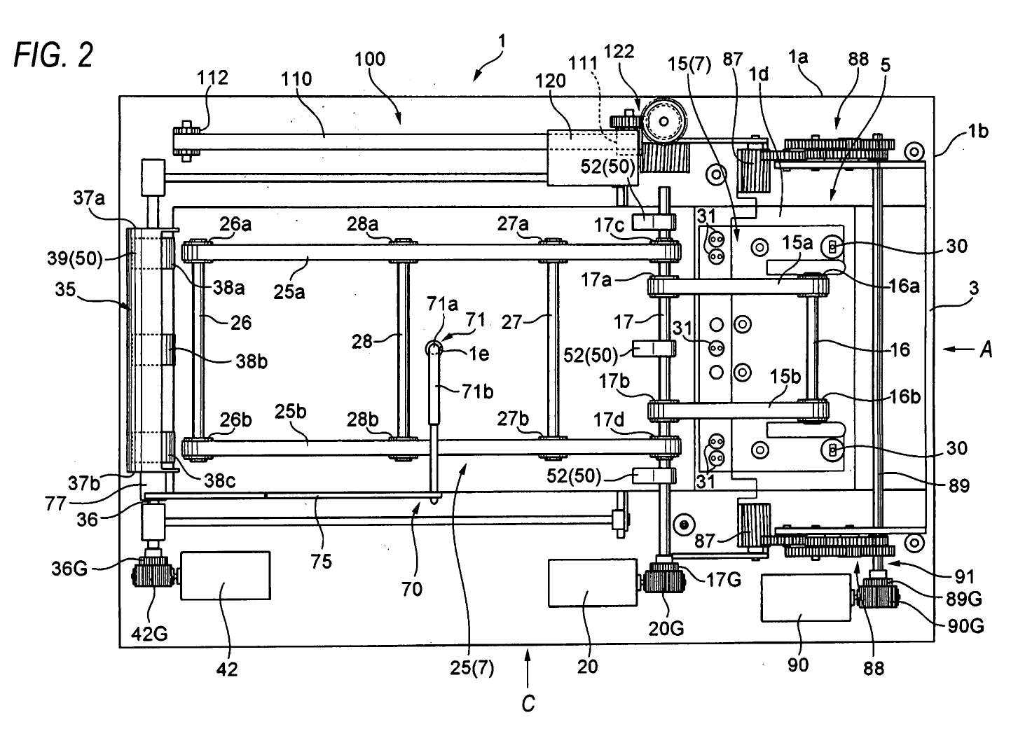

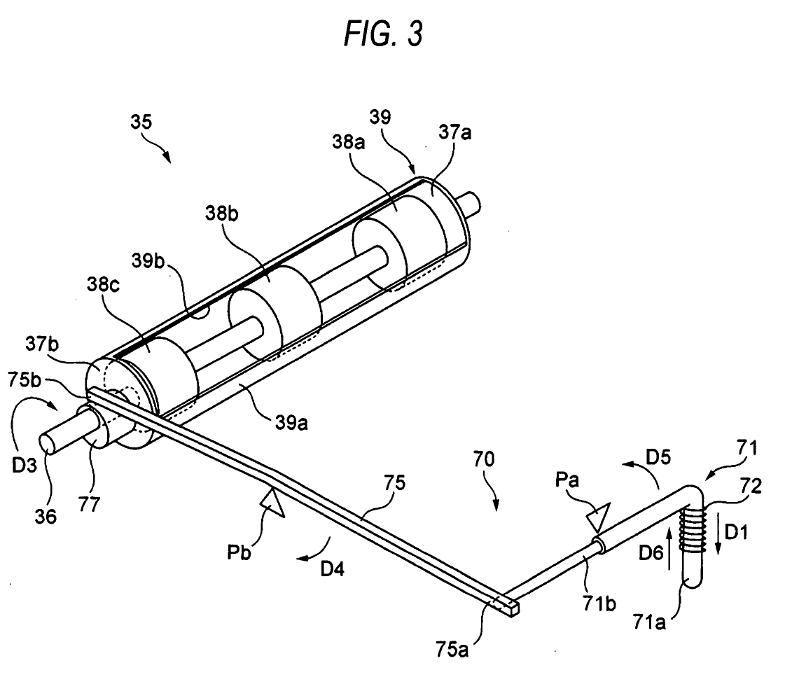

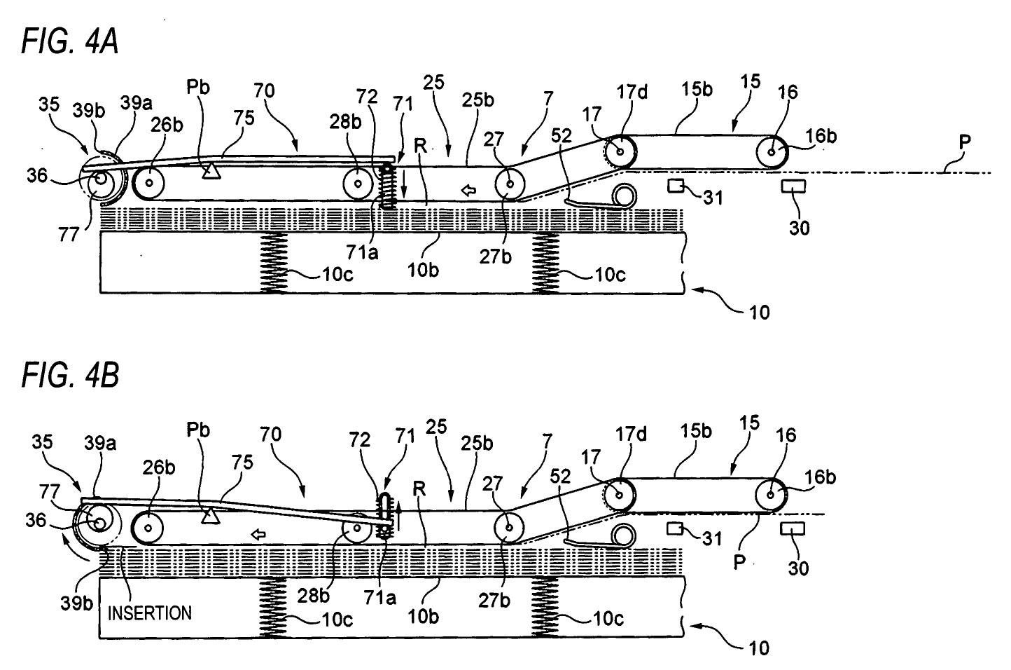

FIGS. 1 to 4B are diagrams illustrating the construction of a bill processing device according to the invention. FIG. 1 is a perspective diagram illustrating the overall construction of the bill processing device. FIG. 2 is a diagram illustrating the inner construction of the bill processing device. FIG. 3 is a perspective view illustrating the schematic construction of a noncontact mechanism and a guide unit which guides the leading end of a bill, which is being conveyed, in a curved manner. FIG. 4A is a side view showing a state where the noncontact mechanism is coming in contact with a bill, seen from the direction of an arrow C of FIG. 1 or 2. FIG. 4B is a side view showing a state where the noncontact mechanism is retreating, seen from the direction of the arrow C of FIG. 1 or 2.

The bill processing device 1 is constructed so as to be installed in a game medium dispenser which is installed between game machines (not shown), such as pachinko (Japanese pinball game) machines or the like. In this case, in the game medium dispenser, other devices (for example, a coin validating device, a recording medium processing device, a power supply device, or the like) are installed on the upper or lower side of the bill processing device 1. However, the bill processing device 1 may be integrated with the above devices or may be constructed separately. Alternately, the bill processing device 1 may be installed independently or together with the above devices in another space, not between the game machines. Further, if a bill is inserted into such a bill processing device 1 and the inserted bill is then determined to be valid, a game medium according to the currency value of the bill is dispensed, or the writing onto a recording medium is performed.

The bill processing device 1 is provided with a casing 1a formed in a rectangular parallelepiped shape. The casing 1a is mounted on a locking section of the game medium dispenser (not shown). On the front surface 1b of the casing 1a, a bill insertion slot 3 is formed in a slit shape, and a bill P is inserted into the inside along the direction of an arrow A in a state where the short side of the bill P is set in the vertical direction thereof, which is hereinafter referred to as the erect state.

Inside the casing 1a, there are provided a bill validating section 5 which validates whether a bill to be inserted is valid or not valid, a bill conveying mechanism 7 which conveys the inserted bill, and a bill storing section 10 which stores the bills, which are determined to be valid, in a stacked manner. In this case, the bill validating section 5 is installed in the vicinity of the bill insertion slot 3 in the insertion direction, and the bill conveying mechanism 7 is installed across a region along the insertion direction A from the bill validating section 5. In addition, the bill storing section 10, disposed in parallel to the bill conveying mechanism 7, can store the bills in a stacked manner in the direction of an arrow B orthogonal to the bill insertion direction A while the bills are set in the erect state (In FIG. 2, the bills are sequentially stored in a stacked manner toward the inmost side in the perpendicular direction to the paper surface).

In the bill validating section 5, a first conveying mechanism 15 is installed, which conveys the bill inserted into the bill insertion slot 3 in the perpendicular state so as to draw the bill to the inside (The first conveying mechanism 15 composes a portion of the bill conveying mechanism 7). In this case, the first conveying mechanism 15 extending along the bill insertion direction A is provided with a pair of conveying belts 15a and 15b which are installed at a predetermined distance. One ends of the respective conveying belts 15a and 15b are wound around tension rollers 16a and 16b mounted on a spindle 16 which is rotatably supported by an inner frame 1d in the side of the bill insertion slot 3. The other ends thereof are wound around tension rollers 17a and 17b mounted on a spindle 17 which is rotatably supported by the inner frame id in the inmost side of the bill validating section 5.

The spindle 17 is rotatably driven by a conveyance motor 20 arranged in the inner frame 1d. In other words, the spindle 17 is rotatably driven through a gear 20G, which is fixed to a driving shaft of the conveyance motor 20, and a gear 17G which is meshed with the gear 20G so as to be fixed to the end of the spindle 17. The conveyance motor 20 is controlled to normally rotate or reversely rotate so as to function as a driving source of the bill conveying mechanism 7.

Although not shown in the drawing, a pitch roller is abutted on the conveying belts 15a and 15b in the longitudinal direction thereof. The bill P inserted into the bill insertion slot is conveyed while being interposed between the conveying belts 15a and 15b and the pitch roller which is abutted on the conveying belts.

The bill conveying mechanism 7 is provided with a second conveying mechanism 25 which is installed to continue to the first conveying mechanism 15. The second conveying mechanism 25 is provided with a pair of conveying belts 25a and 25b which are wider than the conveying belts 15a and 15b constituting the first conveying mechanism 15 and extend along the bill insertion direction A. One ends of the respective conveying belts 25a and 25b are wound around tension rollers 17c and 17d mounted outside the tension rollers 17a and 17b of the spindle 17. The other ends thereof are wound around tension rollers 26a and 26b mounted on a spindle 26 which is rotatably supported by the inner frame 1d. In this case, the distance between the spindles 17 and 26 is set to be shorter than the length of the bill.

Between the spindles 17 and 26, two spindles 27 and 28 along the shaft direction are rotatably supported by the inner frame 1d so as to apply tension to the respective conveying belts 25a and 25b. The conveying belts 25a and 25b are respectively wound around the tension rollers 27a and 28a and the tension rollers 27b and 28b which are mounted on the respective spindles. In addition, the spindle 27 is supported in a state where it is offset with respect to the spindle 17 (refer to FIGS. 4A and 4B). As will be described below, the leading end of the bill to be conveyed is guided in a curved manner. Accordingly, an amount of displacement corresponding thereto should be secured.

The pair of conveying belts 25a and 25b constituting the above-described conveying mechanism 25 are controlled to normally rotate and reversely rotate by the conveying motor 20 which drives the spindle 17 to rotate, similar to the first conveying mechanism 15.

The bill validating section 5 is provided with a bill insertion sensor 30 which is installed in the side of the bill insertion slot 3 from the spindle 16. The bill insertion sensor 30, which is composed of, for example, an optical sensor, detects whether a bill is inserted into the bill insertion slot 3. Further, if the insertion of the bill is detected by the bill insertion sensor 30, a control unit to be described below drives the conveyance motor 20 to rotate (normally rotate) in the bill feeding direction.

The bill validating section 5 is provided with a plurality of bill validating sensors 31 which are installed between the spindles 16 and 17. The bill validating sensor 31 is composed of an optical sensor. When a bill is conveyed by the above-described bill conveying mechanism 7, the bill validating sensor irradiates light onto the conveyed bill. The bill validating sensors 31 are installed in a plurality of places along the direction orthogonal to the bill insertion direction A. The bill validating sensors 31 compares the detection data, which is obtained by the reflected light from the bill or the transmitted light, with data on a normal bill which has been previously stored in a ROM by using a CPU of the control unit to be described below. Then, the bill validating sensors 31 determine whether the bill is valid or not valid. Further, in the present embodiment, when the validation of a bill is performed, the overall region in the longitudinal direction of the conveyed bill is detected.

In the present embodiment, a guide unit 35 is provided in the downstream side of the spindle 26 composing the bill conveying mechanism 7. The guide unit 35 guides the leading end of the bill, which is being conveyed, in a curved manner. The guide unit 35 is installed in the position where the leading end of the bill is guided in a curved manner after the back end of the conveyed bill passes through the bill validating sensors 31.

As shown in FIGS. 2 and 3, the guide unit 35 is provided with a rotation driving shaft 36 which is disposed in parallel to the spindle 26. In both end portions of the rotation driving shaft 36, circular plates 37a and 37b are fixed so as to integrally rotate. Between the plates 37a and 37b, three rollers 38a, 38b, and 38c are rotatably supported at a predetermined distance. In addition, a circular-arc-shaped guide plate 39 is integrally formed in the plates 37a and 37b. The guide plate 39 is spaced at a constant distance (such a distance that a bill can be moved and guided along the outer circumferences of the rollers 38a, 38b, and 38c) with the outer circumferences of the rollers 38a, 38b, and 38c along the shaft direction. The circular arc of the guide plate 39 is preferably formed to have an angle larger than 180° so that the sorting of bills can be reliably performed. The outer circumferences of the rollers 38a, 38b, and 38c are exposed from an opening 39 which is formed by the circular-arc-shaped guide plate 39.

The circular-arc-shaped guide plate 39 not only guides the leading end of a bill in a curved manner between the inner surface thereof and the circumferences of the rollers 38a, 38b, and 38c, but also performs the sorting between the bills stored in a stacked manner in the bill storing section 10 and a bill which is being conveyed, by using a circular-arc-shaped outer circumferential surface 39a thereof. In other words, the sorting is performed so that the bills stored in a stacked manner are not interfered with a bill which is being conveyed.

The rotation driving shaft 36 is rotatably driven by a sorting motor 42 arranged in the inner frame 1d. In other words, the rotation driving shaft 36 is rotatably driven through a gear 42G, which is fixed to a driving shaft of the sorting motor 42, and a gear 36G which is meshed with the gear 42G so as to be fixed to the end of the rotation driving shaft 36. The sorting motor 42 is intermittently controlled to be rotatably driven, with the conveyance motor 20 being driven.

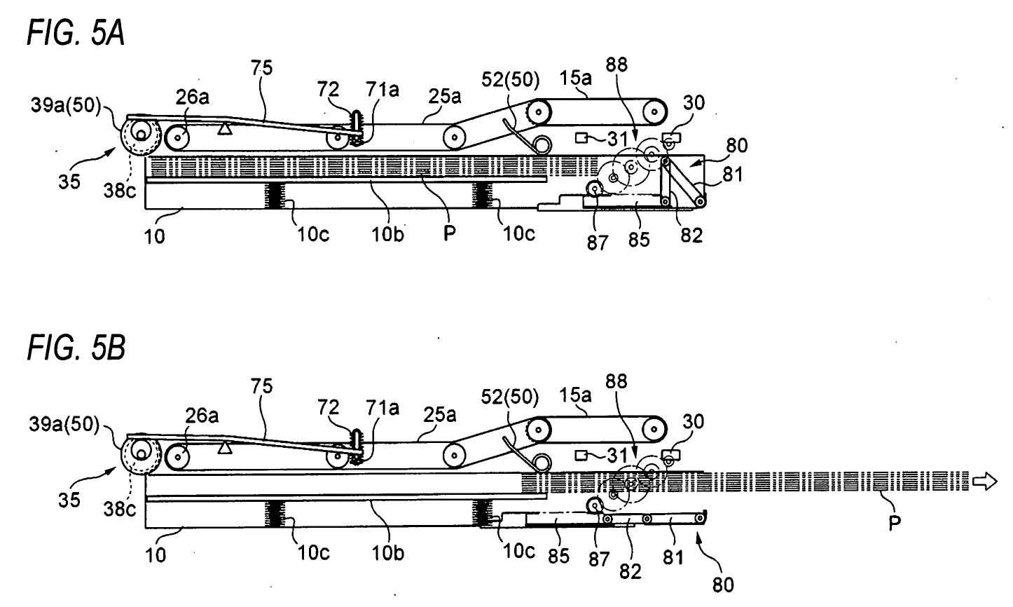

The bill storing section 10 is provided in parallel to the bill conveying mechanism 7 so that a bill which is in the bill conveying mechanism 7 can be stored in a stacked manner as it is (In FIG. 2, the bill storing section 10 is installed in the inmost side of the paper surface). Specifically, as shown in FIGS. 4A and 4B, the bill storing section 10, constructed so as to store a predetermined number of bills in a stacked manner, is provided with a loading plate 10b which is disposed in parallel to the conveying belts 25a and 25b and a biasing spring 10c which biases the loading plate 10b toward the bill conveying mechanism 7 (As shown in FIG. 4B, the bills are sequentially stored on the loading plate 10b in a stacked manner against the biasing force of the biasing spring 10c). In addition, in the side of the bill insertion slot of the bill storing section 10, a shutter mechanism 80 (refer to FIGS. 5A and 5B), which can be opened and closed, is disposed so that the bills stored in a stacked manner are easily taken out. The shutter mechanism is constructed so that bills stored in a stacked manner are discharged as it is by a push-out mechanism which will be described below.

Between the bill storing section 10 and the bill conveying mechanism 7, a sorting mechanism 50 is provided to store bills, which are determined to be valid, in the bill storing section 10 in a stacked manner and to perform the sorting so as to open a conveyance path of a bill which is subsequently inserted. In other words, the sorting mechanism 50 causes the bills, which are determined to be valid, to be subsequently abutted toward the loading plate 10b and performs the sorting so that a bill which is consecutively inserted does not interfere with the bills stored in a stacked manner.

The sorting mechanism 50 of the present embodiment is composed of an outer circumferential surface 39a of the circular arc guide plate 39, which is rotatably driven, and a switching valve 52 arranged between the spindle 17 and the bill storing section 10. In this case, the outer circumferential surface 39a of the guide plate 39 can be engaged with one end of the bill in the longitudinal direction, and the switching valve 52 can be engaged with the other end of the bill in the longitudinal direction.

While the sorting motor 42 is rotatably driven, the guide plate 39 is also rotatably driven. In an initial state shown in FIG. 4A, the outer circumferential surface 39a of the guide plate 39 is in contact with the lower surface of the end portion of the bills stored in a stacked manner so as to press the bills toward the bill storing section 10 (toward the loading plate 10b against the biasing force of the biasing spring 10c). In addition, if the outer circumferential surface 39a of the guide plate 39 is rotatably driven at about 180° in the clockwise direction from the state shown in FIG. 4A, the edge portion of the opening 39b faces the bill insertion slot in order to guide a bill, which is subsequently conveyed, in a curved manner while the outer circumferential surface 39a is in contact with the end portion of the bills stored in the bill storing section 10 in a stacked manner, as shown in FIG. 4B. Then, the bill is positioned is a state where it can be inserted. As a result, since the sorted state between the bill which is subsequently conveyed and the bills stored in a stacked manner is maintained by the outer circumferential surface 39a, the bill which is subsequently conveyed is guided in a curved manner along the inner surface of the guide plate 39.

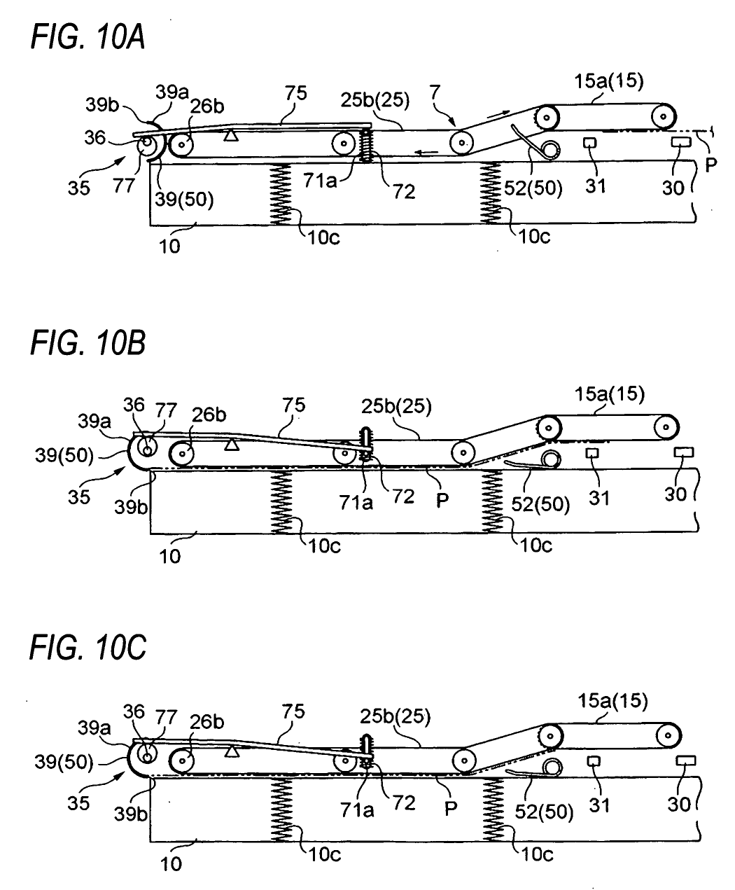

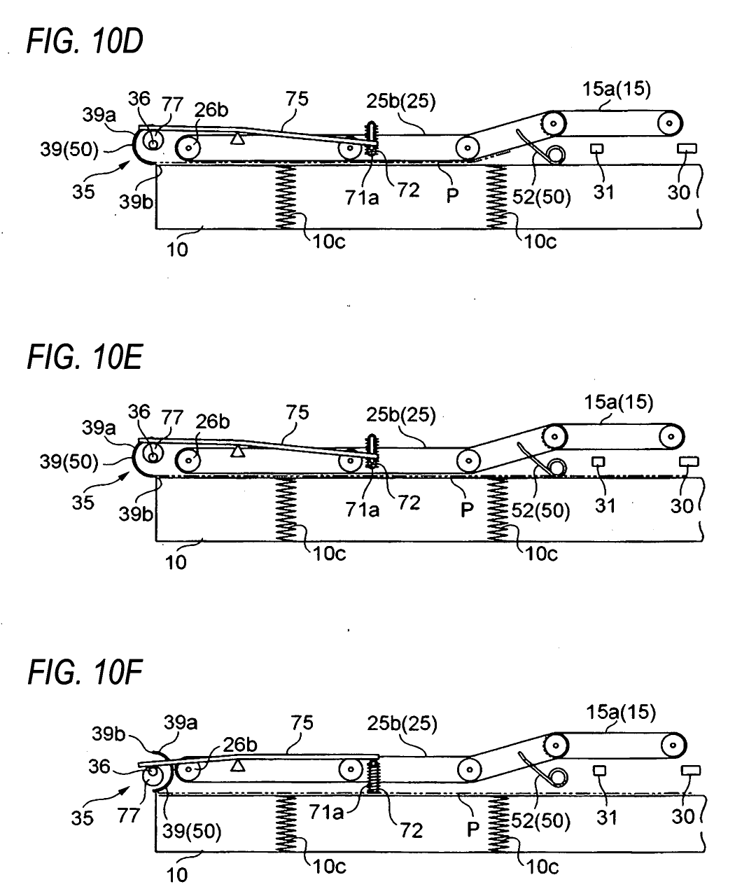

On the other hand, the switching valves 52 are installed in the positions (three places of the center portion and both end portions) spaced at even intervals in the width direction of an inserted bill so as to be abutted on the inserted bill, as shown in FIGS. 2, 4A and 4B. The switching valves 52 are plate-shaped members and are supported in a state where they are biased in the direction where they close the insertion path of the inserted bill (in FIGS. 4A and 4B, they is biased in the clockwise direction). Further, as shown in FIGS. 10A to 10C to be described below, the biasing force is set to such an extent that, when the bill is inserted, the switching valves 52 can be easily rotated in the counter clockwise direction by the conveyance force of the bill against the biasing force. In other words, each surface of the switching valves 52 at the bill storing section 10 is in contact with the end portion of the bills which are stacked and stored in the bill storing section 10. Therefore, the switching valves perform the sorting between the bills and a bill which is inserted.

In the inner frame 1d, a noncontact mechanism 70 is provided, which causes the bill stored in the bill storing section 10 not to come in contact with the conveying belts (conveying sections) 25a and 25b of the bill conveying mechanism 25 until a bill is carried in the storage position of the bill storing section 10 by the bill conveying mechanism 25. In other words, although the conveying belts 25a and 25b of the bill conveying mechanism 25 is rotatably driven, the bill which is stacked last and stored in the bill storing section 10 (which faces the conveying belts 25a and 25b) does not come in contact with the conveying belts 25a and 25b, which are rotatably driven, by the noncontact mechanism 70.

The noncontact mechanism 70 of the present embodiment is provided with an abutting member 71, which is constructed so as to be abutted on the substantial center of the bill which is stacked last and stored in the bill storing section 10 and to appear and disappear with respect to the conveyance path R of a bill, as shown in FIGS. 4A and 4B. As shown in FIG. 3, the abutting member 71 is provided with an abutting section 71a and a base section 71b bent in an L shape. The abutting section 71a projects toward the bills stored in a stacked manner through a small hole 1e formed on the inner frame 1d. Between the abutting section 71a and the inner frame 1d, a biasing spring 72 (omitted in FIG. 2) is provided to bias the abutting section 71a at all times in the direction where it projects (the direction where it is in contact with the bills). In other words, the abutting section 71a is biased by the biasing force of the biasing spring 72 (the biasing force in the direction of an arrow D1 in FIG. 3) so as to press the substantial center of the bills stored in a stacked manner.

As described above, the abutting member 71 is driven so that the abutting section 71a thereof appears and disappears with respect to the conveyance path R of a bill. Specifically, when a newly inserted bill passes through the abutting section 71a (when it is passing through the abutting section 71a), the abutting section 71a retreats from the conveyance path R so as not to prevent the conveying of the bill. Otherwise, when the conveying belts 25a and 25b are rotatably driven, the abutting section 71a projects onto the conveyance path R so as to be abutted on the bills stored in a stacked manner. Then, the bills are maintained to be separated from the conveying belts 25a and 25b.

In the present embodiment, the abutting member 71 is constructed so as to be driven by using the sorting motor 42 which drives the rotation driving shaft 36 of the guide unit 35 to rotate. As shown in FIG. 3, in the abutting member 71, the center of the base section 71b is swingably supported by a supporting point Pa, and the leading end thereof is in contact with the lower surface of one end 75a of a connection piece 75 extending along the conveyance direction of a bill. Further, the center of the connection piece 75 is swingably supported by a supporting point Pb, and the other end 75b thereof is engaged with an eccentric cam 77 which is integrally mounted on the rotation driving shaft 36.

FIG. 3 shows an initial position of the eccentric cam 77. If the rotation driving shaft 36 is rotatably driven at about 180° in the clockwise direction D3 in this state, the other end 75b of the connection piece 75 is raised. In accordance with that, the one end 75a of the connection piece 75 is rotated in the direction of an arrow D4, centered on the supporting point Pb. As the one end 75a is rotated in the direction of the arrow D4, the base section 71b of the abutting member 71 is rotated in the direction of an arrow D5, centered on the supporting point Pa. As a result, the abutting section 71a is raised in the direction of an arrow D6 (the direction away from the bill) against the biasing force of the biasing spring 72. In other words, as the eccentric cam 77 is rotatably driven at about 180° from the state shown in FIG. 3, the abutting section 71a is driven in the direction of the arrow D6 against the biasing force of the biasing spring 72 so as to retreat from the conveyance path R.

If the rotation driving shaft 36 is rotatably driven once again at about 180° in the clockwise direction D3, it returns to the initial position shown in FIG. 3. The abutting section 71a is pressed to the substantial center of the bill, which is stacked last and stored in the bill storing section 10, by the biasing force of the biasing spring 72 (that is, the bill and the conveying belts 25a and 25b are maintained to be separated).

In the arrangement example shown in FIG. 3, the initial position of the eccentric cam 77 does not coincide with the initial position of the guide plate 39 of the guide unit 35. As shown in FIG. 4A, when the eccentric cam 77 is in the initial position, the opening 39b of the guide plate 39 faces the back side.

As the shutter mechanism 80 arranged in parallel to the bill insertion slot 3 is driven so as to be opened, the bills which are stored in a stacked manner in the bill storing section 10 can be taken out in a state where they are stacked (refer to FIGS. 5A and 5B). The shutter mechanism 80 is composed of a shielding plate 81 which is inclined to close a bill-take-out opening section and a rotating arm plate 82 which is connected to the shielding plate 81. In this case, one end of the shielding plate 81 is rotatably supported by the frame of a device main body, and the other end thereof is rotatably supported by one end of the rotating arm plate 82. In addition, the other end of the rotating arm plate 82 is rotatably supported by a pair of rack members 85 (only one of the pair is shown), which is provided so as to move along the bill conveyance direction, in both sides of the direction orthogonal to the direction where the bill is carried in.

As shown in FIG. 5A, the rotating arm plate 82 is set in the direction where the bills are stacked, in a state where the shielding plate 81 is closed. As the pair of rack members 85 are driven to slide from the state shown in FIG. 5A to a state shown in FIG. 5B, the rotating arm plate 82 slips between the bills stored in a stacked manner and the frame wall. If the rack members 85 are further driven to slide, the rotating arm plate 82 is rotated so as to be substantially flush with the rack members 85, as shown in FIG. 5B. Further, in accordance with the operation of the rotating arm plate 82, the shielding plate 81 is rotated so as to be in surface contact with the frame wall, centered on the base end thereof. Finally, the discharge path of bills is opened so that the bills can be taken out.

As shown in FIG. 2, the rack members 85 are engaged with a pinion 87 through gear trains 88 installed in both sides. The respective gear trains 88 are connected to each other by a rotation driving shaft 89 which is rotatably driven by a shutter motor 90. In other words, as a motor gear 90G of the shutter motor 90 is connected to a gear 89G fixed to the rotation driving shaft 89, the rotation driving shaft 89 is rotatably driven, and the pair of rack members 85 are synchronously driven through the pinion 87 and the gear trains 88 arranged in both sides of the rotation driving shaft 89 (the shielding plate 81 is driven to be opened and closed as shown in FIGS. 5A and 5B).

After the shielding plate 81 is opened as described above, a push-out mechanism 100 is engaged with the bills which are stored in a stacked manner in the loading plate 10b of the bill storing section 10. The bills which are stacked are pushed out to the side of the shielding plate 81 which is forced to be opened.

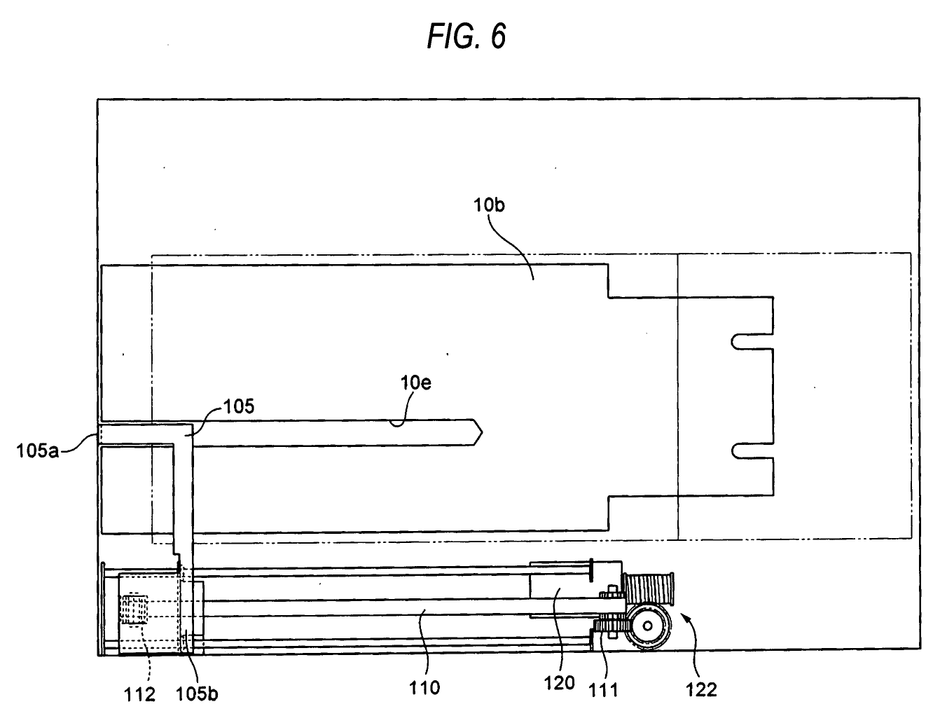

Such a push-out mechanism can be constructed as shown in, for example, FIGS. 2, 6, and 7. That is, on the loading plate 10b of the bill storing section 10, a long groove 10e is formed to extend along the longitudinal direction of a bill, and a push-out arm 105 is arranged so as to move along the long groove. In one end of the push-out arm 105, an abutting piece 105a is formed to be bent along the direction where the bills are stacked so as to be abutted on the edges of the stacked bills. In the other end of the push-out arm 105, an interposing section 105b is formed in the frame of the device main body to interpose a driving belt 110 which is tensely provided so as to be rotatably driven.

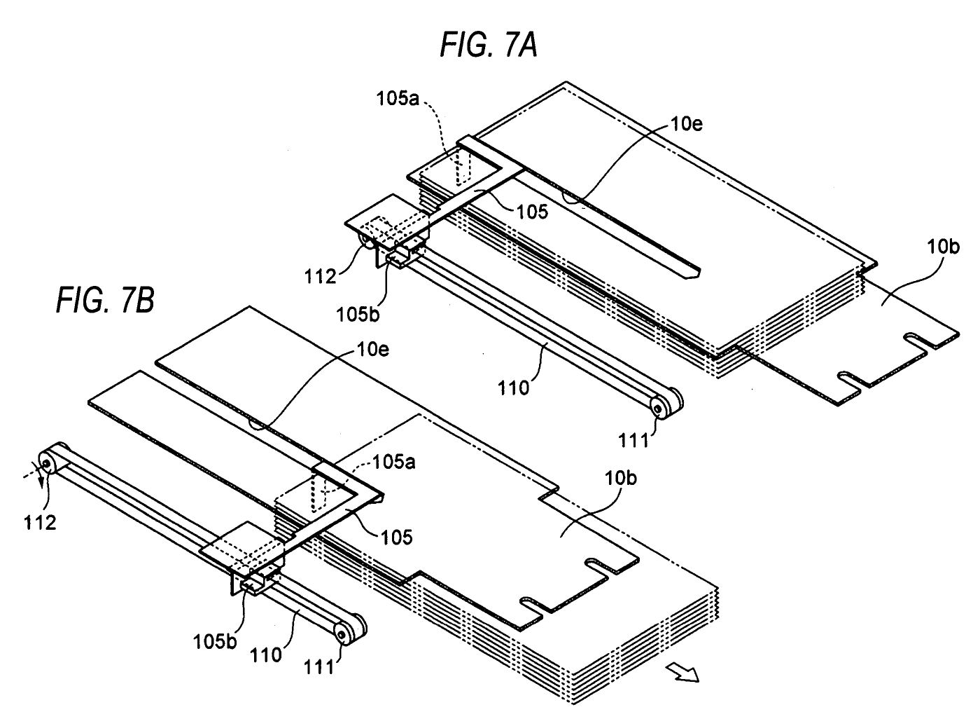

The driving belt 110 is tensely provided between tension rollers 111 and 112 in both ends thereof. As one tension roller 111 is rotatably driven through a push-out motor 120 provided in the frame of the device main body and a gear train 122 connected to the driving shaft of the push-out motor 120, the push-out arm 105 can be driven in the bill discharge direction. When the push-out arm 105 is driven to slide as described above, the bills stacked on the loading plate 10b are driven to slide so as to be discharged through the shielding plate 81 which is opened, as shown in FIGS. 7A and 7B.

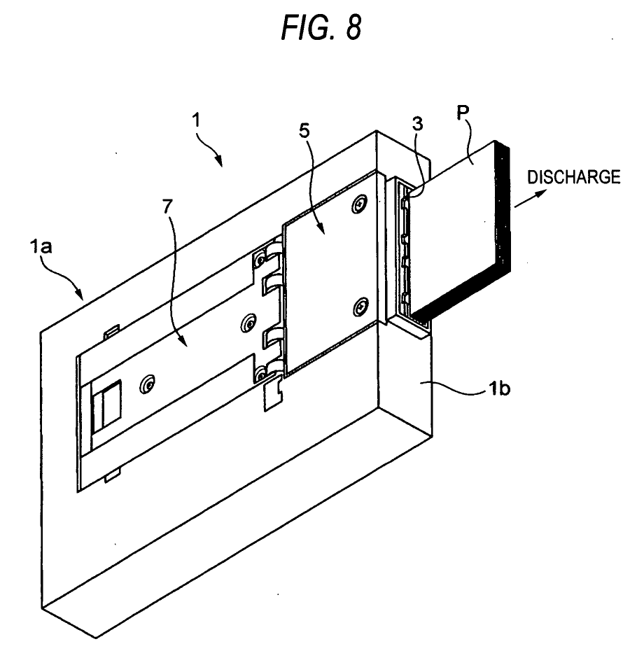

As a result, the shutter motor 80 is opened by driving the shutter motor 90. In synchronization with that, the push-out motor 120 is driven. Then, as shown in FIG. 8, the bills stored in a stacked manner can be taken out as they are.

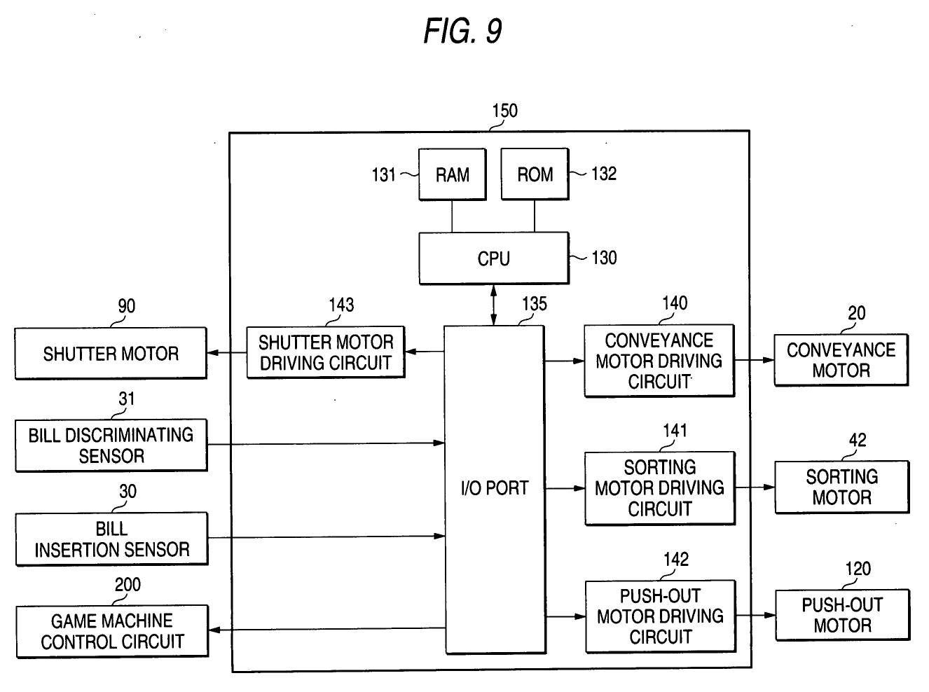

FIG. 9 is a block diagram illustrating a constructional example of the control unit which controls an operation of the bill processing device 1.

The control unit is provided with a control circuit board 150 which controls operations of the respective actuators. The control circuit board 150 is composed of a CPU 130 which has a function of controlling various driving devices such as the conveyance motor 20, the sorting motor 42, the push-out motor 120, the shutter motor 90, and the like, a ROM 131 which stores operation programs of the various driving devices and detection data on a normal bill, and a control RAM 132.

The CPU 130 is connected to a conveyance motor driving circuit 140, a sorting motor driving circuit 141, a push-out motor driving circuit 142, and a shutter motor driving circuit 143, which drive the various driving devices, through an I/O port 135. The operation of each of the driving devices is controlled by a control signal from the CPU 130 according to the operation program. In addition, the CPU 130 receives a detection signal from the bill insertion sensor 30 and a detection signal from the bill validating sensor 31 through the I/O port 135. Based on the detection signals, the conveyance motor 20 is controlled to normally rotate or reversely rotate through the conveyance motor driving circuit 140, and the sorting motor 42 is controlled to be rotatably driven through the sorting motor driving circuit 141.

In addition, the CPU 130 is connected to a control circuit 200, which is arranged in the main body of the game machine (not shown) to execute a game process, so as to transmit game value information according to the value of an inserted bill to the game machine.

Next, in the bill processing device having such a construction, an operation when the bill P is inserted will be described with reference to FIGS. 1 to 4B and 10A to 10F. FIGS. 10A to 10F are schematic views consecutively showing operations of the bill conveying mechanism 7, the guide unit 35, the sorting mechanism 50, and the abutting section 71a of the abutting member 71 in the noncontact mechanism 70, which have been described, when the bill P is inserted.

First, as shown in FIG. 1, if the bill P is inserted into the bill insertion slot 3 in the erect state where it is set to be perpendicular, the insertion thereof is detected by the bill insertion sensor 30. If the bill insertion sensor 3b detects the insertion of bill, the conveyance motor 20 is driven to normally rotate, and the first and second conveying mechanisms 15 and 25 of the bill conveying mechanism 7 are rotatably driven in an arrow direction of FIG. 10A. Accordingly, the bill P inserted through the bill insertion slot 3 is introduced to the inside.

At this time, the guide plate 39 of the guide unit 35 and the eccentric cam 77 are positioned in the initial position, as shown in FIG. 4A. The sorting between the bills stored in the bill storing section 10 and a bill which is newly inserted is performed by the sorting mechanism (the outer circumferential surface 39a of the guide plate 39 and the switching valve 52). Further, the bills stored in the bill storing section 10 are held down toward the loading plate by the abutting section 71a of the abutting member of the noncontact mechanism 70. As a result, the bills stored in the bill storing section 10 are maintained to be separated from the conveyance belts 25a and 25b by the abutting section 71a (the noncontact state is maintained). Even though there is a flexion on the bills, the bills stored in the bill storing section 10 do not come in contact with the conveying belts 25a and 25b which are being driven, and a jam does not occur.

When the bill P is conveyed inside, the bill validating sensor 31 detects the bill which is being conveyed, and the validity of the bill is determined by the control unit. In this case, before the conveyed bill passes through the abutting section 71a, the abutting section 71a is driven so as to retreat from the conveyance path. Specifically, as shown in FIG. 10B, as the rotation driving shaft 36 is rotatably driven at about 180° in the clockwise direction, the abutting section 71a is driven to be separated from the bill against the biasing force of the biasing spring 72 through the eccentric cam 77 and the connection piece 75, and is retreated so as not to obstruct a bill which is newly conveyed.

The noncontact mechanism 70 (the abutting section 71a) may be driven by driving the sorting 42 at a timing when a predetermined time is counted after the bill insertion sensor 30 or the bill validating sensor 31 detects the bill. In the present embodiment, the bill validating sensor 31 detects the whole bill P in the longitudinal direction, which is conveyed (FIG. 10B).

If the bill P is conveyed to pass through the bill validating sensor 31 as described above, the switching valve 52 is rotated by the conveyance force in the counter clockwise direction against the biasing force, as shown in FIG. 10B. As shown in FIG. 10B, if the rotation driving shaft 36 is driven to rotate at about 180° in the clockwise direction, the opening 39b of the guide plate 39 is rotated to the side of the bill insertion slot so as to receive a bill. At this time, even though the bills are stored in a stacked manner in the bill storing section 10, the sorted state of the bill placed uppermost is maintained by the outer circumferential surface 39a of the rotating guide plate 39.

When the back end of the bill P passes through the bill validating sensor 31 and thus the overall portion of the bill is detected in the longitudinal direction thereof, the leading end of the bill P is guided in a curved manner between the circular-arc-shaped guide plate 39 of the guide unit 35 and the outer circumference surfaces of the rollers 38a, 38b, and 38c. At this time, the back end of the bill P is placed in the position where it does not pass through the switching valve 52 (FIG. 10C).

In the control unit, the conveyance motor 20 is driven to reversely rotate, when the inserted bill P is determined to invalid. The reverse rotation causes the bill P, which is in a state shown in FIG. 10C, to be discharged from the bill insertion slot 3 so as to be remanded. In addition, when the bill P is determined to be valid, the conveyance motor 20 is driven to normally rotate until the back end of the bill P passes through the switching valve 52 (FIG. 10D). Accordingly, the switching valve 52 returns to the initial position of FIG. 10A, and the leading end of the bill is guided in a curved manner by the guide unit 35.

The conveyance motor 20 is driven to normally rotate until the back end of the bill P passes through the switching valve 52. After that, the conveyance motor 20 is driven to reversely rotate (switch back control) in order to switch back the bill at a predetermined distance. At this time, the back end portion of the bill P is sorted by the switching valve 52 and is prevented from being interfered with a bill, which is consecutively inserted, without being once again conveyed to the side of the first conveying mechanism 15. The leading end portion of the bill P is placed in the introduction port portion of the circular-arc-shaped guide plate 39 so as to be positioned in a state before the bill is guided in a curved manner (FIG. 10E). The switch back control herein means that, when the bill is determined to be valid by the bill validating sensor 31, the driving of the conveyance motor 20 is controlled so as to convey (return) the bill at a constant distance toward the bill insertion slot after the back end of the bill passes through the switching valve 52 and the leading end of the bill is guided in a curved manner by the guide plate 39.

In this state, the sorting motor 42 is rotatably driven so as to rotate the guide plate 39 at about 180° in the clockwise direction so that the guide plate 39 returns to the initial position shown in FIG. 10A. The rotation causes the leading end of the bill P to run on the guide plate 39 (FIG. 10F). Finally, when the guide plate 39 returns to the initial position shown in FIG. 10A, the leading end of the bill P is maintained to be in contact with the loading plate 10b by the outer circumferential surface 39a of the guide plate 39, as shown in FIG. 4B. In other words, the bill switched back is transferred toward the bill storing section 10 in the direction orthogonal to the insertion direction of the bill by the guide plate 39, which is rotatably driven, so as to be in contact with the loading plate 10b. At this time, the abutting member 71a is pressing the bill, and the uppermost bill is maintained to be separated from the conveying belts 25a and 25b.

If bills are sequentially inserted from the bill insertion slot 3, the above-described operation is repeated. Finally, in the loading plate 10b, a large number of bills are stored in a stacked manner, as shown in FIGS. 4A and 4B. In this state, the leading ends of the bills stored in a stacked manner are pressed toward the loading plate 10b by the guide plate 39, and the back ends thereof are pressed toward the loading plate 10b by the switching valve 52 (the sorting between the bills and a bill which is newly carried is performed by the guide plate 39 and the switching valve 52).

The bills stored in a stacked manner in the bill storing section 10 as describe above are discharged by the push-out mechanism 100 as they are. In other words, as shown in FIGS. 7A and 7B, the push-out arm 105 which is abutted on the edges of the bills stored in a stacked manner is driven to slide by the push-out motor 120. Then, the bills stored in a stacked manner are moved in the discharge direction, as they are, so as to be discharged as shown in FIG. 8. As such, with the push-out mechanism 100 being provided, the bills stored in the bill storing section 10 can be easily taken out.

According to the bill processing device 1 of the above-described embodiment, the bill inserted into the bill insertion slot 3 is conveyed by the bill conveying mechanism 7 as it is. When it is being conveyed, the validity thereof is determined by the bill validating sensor 31. Further, when the validity of the bill is determined by the bill validating sensor 31, the leading end of the bill which is being conveyed is guided in a curved manner by the guide unit 35. Therefore, although the whole region in the longitudinal direction of the bill is set to be detected, the length of the conveyance path in the longitudinal direction of the bill can be set to be short. As a result, while the precision of validating a bill is improved, the depth of the bill processing device 1 can be made as compact as possible.

In addition, the bill which is determined to be valid is switched back at a constant distance toward the bill insertion slot 3 and is then transferred from this position toward the bill storing section 10 provided in parallel to the bill conveying mechanism 7 by the sorting mechanism 50. In other words, since the bill storing section 10 stores a transferred bill in a stacked manner in the direction orthogonal to the bill insertion direction, the bills can be effectively stored in a space which is limited in the width direction.

Since the sorting mechanism 50 opens the conveyance path such that a bill which is subsequently inserted by the bill conveying mechanism 7 is not interfered, a jam or clogging does not occur between the bills stored in a stacked manner and a bill which is newly inserted, and the bill can be conveyed in a stable state. Further, in such a construction, the bill which is stacked last and stored in the bill storing section 10 is maintained to be separated from the conveying sections (the conveying belts 25a and 25b in the present embodiment) of the bill conveying mechanism by the noncontact mechanism 70. Therefore, when the conveying sections are being driven, the bill is prevented from coming in contact with the conveying sections even though there is a flexure of the bill which is last stacked. Further, the bill is transferred in the conveyance direction, so that a jam is prevented from occurring.

In the above-described embodiment, since the circular-arc-shaped guide plate 39 constituting the guide unit 35 has a function of transferring a bill toward the bill storing section 10 as well as a function of performing the sorting between the bills stored in a stacked manner and an inserted bill, the overall construction can be simplified. Further, since the circular-arc-shaped guide plate 39 has a function of pushing a bill into the loading plate 10b, a separate member such as a push-in plate does not need to be arranged.

According to the shutter mechanism 80 and the push-out mechanism 100 which are driven as described above, the bills stored in a stacked manner in the bill storing section 10 can be discharged as they are. Therefore, the overall construction of the device is simplified. Further, a casing (money safe) for storing bills does not need to be installed, thus reducing the amount of time required in taking out bills.

Although the embodiment of the invention has been described so far, the present invention can be constructed, as will be described below, except for the above-described embodiment.

In the noncontact mechanism 70, when the conveying sections of the bill conveying mechanism are being driven, the bills which are stored in a stacked manner to be opposite to the conveying sections can be maintained so as not to come in contact with the conveying sections until a new bill is carried in. In this case, the construction of the mechanism and the method where the noncontact state is maintained can be properly modified. In addition, in the above-described embodiment, the driving motor (the sorting motor 42) for driving the guide unit 35 is used as a driving source for driving the noncontact mechanism 70. However, a dedicated driving source may be arranged so as to drive the noncontact mechanism 70, and a driving source for driving a separate member may be used to drive the noncontact mechanism 70.

In the guide unit 35 which guides the leading end of a bill in a curved manner as described above, the shutter mechanism 80, and the push-out mechanism 100, the constructions thereof and the operational method can be properly modified. Moreover, in the bill processing device of the invention, the guide unit 35 which guides the leading end of a bill in a curved manner and the push-out mechanism 100 which is abutted on the back end of a bill so as to push out the bill may not be arranged. The constructions of the bill conveying mechanism for conveying a bill, the sorting mechanism for sorting bills, the driving source for driving a driving member such as the bill conveying mechanism, and the power transmission mechanism can be also modified properly.

The bill processing device of the invention can be installed in external devices such as various vending machines, which deal with bills, with exception that it is installed between various game machines.

Further, according to the invention, the abutting member appears and disappears on the conveyance path of the bill so as to be abutted on the bills stored in a stacked manner. Therefore, while the bill conveying mechanism is driven, and when a bill does not actually move along the region of the bill storing section, the abutting member is projected to be abutted on the bills stored in a stacked manner so that the bills do not come in contact with the conveying sections of the bill conveying mechanism. When a bill is moving along the region of the bill storing section, the abutting member is retreated so as not to obstruct the movement of the bill.

Further, according to the invention, when the validity of the bill is determined by the bill validating sensor, the leading end of the conveyed bill is guided in a curved manner. Therefore, even though the entire region in the longitudinal direction of the bill is detected, the length of the conveyance path in the longitudinal direction of the bill can be set to be short, which makes it possible to make the depth of the bill processing device compact. Further, the bill which is determined to be valid is switched back at a constant distance toward the bill insertion slot so as to be transferred from this position toward the bill storing section arranged in parallel to the bill conveying mechanism. At this time, the sorting is performed by the sorting mechanism so that the bills stored in a stacked manner do not interfere with a bill which is subsequently inserted by the bill conveying mechanism. Therefore, between the bills stored in a stacked manner and the inserted bill, a jam or clogging does not occur. Further, since the above-described abutting member according to the second aspect can be retreated from the conveyance path of the bill during such an operation, there is no difficulty in conveying the bill.

Further, according to the invention, the abutting member is driven with the guide member being rotated. Therefore, the driving source can be shared, and the overall construction of the device can be simplified. Further, more space is saved.

What is claimed is:

1. A bill processing device comprising:
a bill insertion slot into which a bill is inserted;
a bill conveying mechanism that conveys the bill inserted from the bill insertion slot along the insertion direction or returns the bill, which is being inserted, toward the bill insertion slot;
a bill validating sensor that validates whether the bill inserted into the bill insertion slot is valid or not valid;
a bill storing section that is provided in parallel to the bill conveying mechanism and stores bills in a stacked manner in the direction orthogonal to the bill insertion direction;
a sorting mechanism that stores the bills, which are determined to be valid by the bill validating sensor, in the bill storing section in a stacked manner and that performs the sorting between the bills and a bill which is subsequently inserted; and
a noncontact mechanism that causes the bills stored in the bill storing section not to come in contact with the bill conveying mechanism, until the bill is carried in the storage position of the bill storing section by the bill conveying mechanism.

2. The bill processing device according to claim 1, wherein
the noncontact mechanism appears and disappears with respect to a conveyance path of the bill with the bill being conveyed, and has an abutting member, which is abutted on the bill when projected.

3. The bill processing device according to claim 1, further comprising:
a guide unit that guides the leading end of the bill in a curved manner when the bill is being conveyed along the insertion direction and the bill validating sensor detects the validity of the bill; and
a control unit that controls the bill conveying mechanism so that the bill is switched back at a constant distance toward the bill insertion slot when the inserted bill is valid.

4. The bill processing device according to claim 2, further comprising:
a guide unit that guides the leading end of the bill in a curved manner when the bill is being conveyed along the insertion direction and the bill validating sensor detects the validity of the bill; and
a control unit that controls the bill conveying mechanism so that the bill is switched back at a constant distance toward the bill insertion slot when the inserted bill is valid.

5. The bill processing device according to claim 4, wherein:
the guide unit has a guide member that guides the leading end of the bill in a curved manner and that is rotatably driven so that the sorting between the bills stored in a stacked manner and the bill guided in a curved manner is performed; and
the abutting member is connected to the guide unit so as to appear and disappear with the rotating drive of the guide member.
